(19) United States
(12) Patent Application Publication
(10) Pub. No.: US 2002/0136264 A1
(43) Pub. Date: Sep. 26, 2002

(54) Spread spectrum measurement device

(76) Inventors: Earl C. Herleikson, Lebanon, ME (US); Rainer Elschenbroich, Boeblingen (DE); Dieter Woehrle, Waiblingen (DE); Richard A. Baumgartner, Palo Alto, CA (US); James M. Lindauer, San Francisco, CA (US); James L. Miller, Westford, MA (US)

Correspondence Address: PHILIPS ELECTRONICS NORTH AMERICAN, 580 WHITE PLAINS ROAD, TARRYTOWN, NY, 10591, US

(21) Appl. No.: 09/812,431

(22) Filed: Mar. 20, 2001

(51) Int. Cl. H04B 1/69

(52) U.S. Cl. 375/130

(57) ABSTRACT

The present disclosure relates to a spread spectrum measurement device with which a desired condition can be measured. In use, the spread spectrum measurement device is used to direct a spread spectrum signal into medium (e.g., a patient's body), detect a parameter that corresponds to the signal directed into the medium, generate a measured parameter signal from the detected parameter, and analyze the measured parameter signal to determine the desired condition. In one arrangement, a spread spectrum current signal is transmitted into the medium and a voltage signal is detected. From this voltage signal, an impedance signal is generated with which electrode contact impedance, patient heart rate, and/or patient respiration rate can be measured.

### FIELD OF THE INVENTION

The present disclosure relates to a spread spectrum measurement device. More particularly, the disclosure relates to a device that uses spread spectrum transmission and detection techniques to measure medical conditions such as contact impedance, patient heart rate, and patient respiration rate.

### BACKGROUND OF THE INVENTION

In many fields, diagnostic measurements are made by transmitting signals into a medium and monitoring the signals to detect resistance to or modulation of the signals. For instance, in the medical field, defibrillators often transmit high frequency signals into the body to determine the contact impedance of the defibrillator electrodes. Furthermore, in ultrasound imaging, ultrasonic signals are transmitted into the body and the echoes of the signals are received to image tissue and/or blood flow. In yet another example, pulse oximeters are used to transmit pulsed red and infrared light energy signals into the body and to measure the transmitted red and infrared light levels to determine the oxygen saturation level and pulse rate of the blood flow. Other devices simply detect electrical signals. For instance, electrocardiograph (ECG) machines are used to detect electrical signals related to heart activity.

Although generally effective in providing the desired information, present measurement techniques can be problematic. First, the detectors used in such applications can be sensitive to external noise. Such noise can originate from many different types of electrical equipment including, for instance, medical devices, power lines, fluorescent lights, mobile telephones, etc. Where the frequency of the noise coincides with the frequency being detected, the noise can interfere with the signals and therefore lead to incorrect readings.

Another problem posed by present measurement techniques relates to electrical radiation. In particular, the transmitted signals can create interference with other equipment as well as compliance problems with various regulatory bodies including, for instance, the Federal Communications Commission (FCC). Therefore, it would be desirable to have an apparatus and method for measuring desired conditions (e.g., patient conditions) that avoid the aforementioned problems.

### SUMMARY OF THE INVENTION

The present disclosure relates to a spread spectrum measurement device with which a desired condition in measured. In use, the spread spectrum measurement device is used to direct a spread spectrum signal into a medium, detect a parameter that corresponds to the signal directed into the medium, generate a measured parameter signal from the detected parameter, and analyze the measured parameter signal to determine the desired condition. In one arrangement, a spread spectrum current signal is transmitted into a patient's body and a voltage signal is detected. From this voltage signal, an impedance signal is generated that is used to measure electrode contact impedance, CPR activity, patient heart rate, and/or patient respiration rate.

The spread spectrum measurement device can comprise a medium interface, a signal transmitter configured to produce a spread spectrum input signal, a signal detector configured to detect a spread spectrum signal at the interface, and a signal processor configured to analyze the spread spectrum signal detected by the signal detector.

The features and advantages of the invention will become apparent upon reading the following specification, when taken in conjunction with the accompanying drawings.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a block diagram of an example spread spectrum measurement device of the present invention.

FIG. 2 is a flow diagram illustrating a first method for measuring a desired condition with the device of FIG. 1.

FIG. 3 is a flow diagram illustrating a second method for measuring a desired condition with the device of FIG. 1.

### DETAILED DESCRIPTION

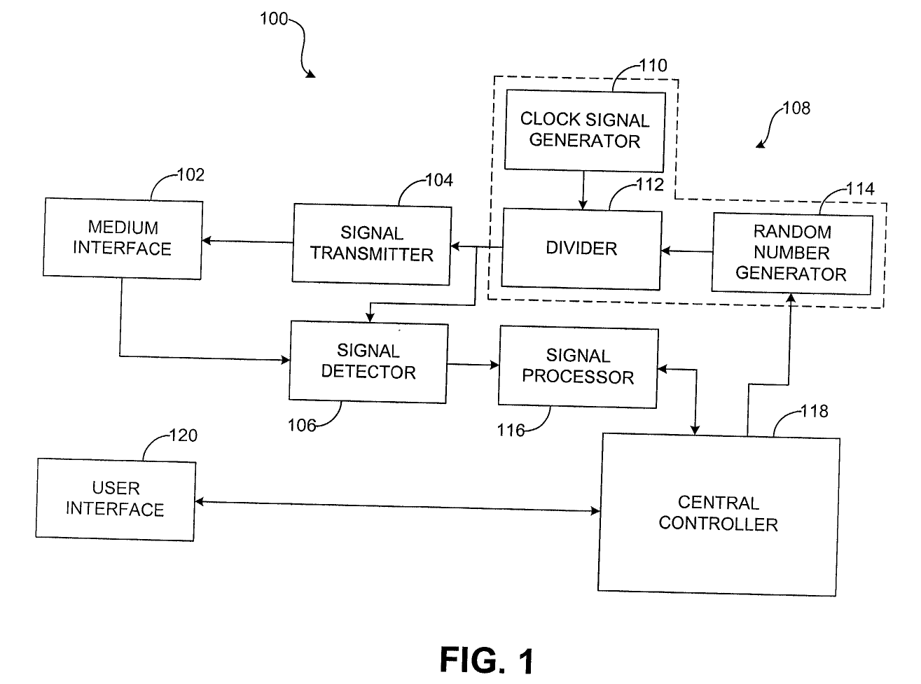

Referring now in more detail to the drawings, in which like numerals indicate corresponding parts throughout the several views, FIG. 1 illustrates an example spread spectrum measurement device 100 of the present invention. As will be understood from the discussion that follows, this measurement device 100 is implemented in a medical device or system. For instance, the spread spectrum measurement device 100 shown in FIG. 1 can be implemented in a defibrillator, pulse oximeter (SpO₂), an electrocardiograph (ECG) machine, or a blood pressure monitor (not shown). It will be appreciated that FIG. 1 does not necessarily illustrate every component of the device 100, emphasis instead being placed upon the components most relevant to the present invention.

As indicated FIG. 1, the spread spectrum measurement device 100 comprises a medium interface 102 that communicates with the medium that is being monitored. By way of example, this interface 102 can comprise a patient interface including one or more electrodes used with a defibrillator or ECG machine. The device 100 further comprises a signal transmitter 104 that directs an input signal into the medium, and a signal detector 106 that detects a parameter that corresponds to the input signal. By way of example, the signal transmitter 104 is a current signal transmitter and the signal detector 106 is a voltage detector. Alternatively, the signal transmitter 104 can be a voltage signal transmitter and the signal detector 106 can be a current detector. In another arrangement, the transmitter can be an electromagnetic radiation source such as light source and the detector can be an electromagnetic radiation detector such as a light detector. In yet another example, the transmitter is an acoustic source and the detector is a corresponding transducer.

Irrespective of the type of input signal, the input signal comprises a spread spectrum signal. In one arrangement, this spread spectrum signal is created with the aid of a random signal generator 108 that is in electrical communication with the signal transmitter 104 as well as the signal detector 106. By way of example, the generator 108 can comprise a clock signal generator 110, a divider 112, and a random number generator 114. The clock signal generator 110 produces a clock signal in the form of a square waveform that toggles from an “on” position to an “off” position at a particular frequency. As its name suggests, the random number generator 114 randomly generates numbers within a particular range. The numbers generated by the number generator 114 are provided to the divider 112, which also receives the clock signal from the clock signal generator 110. The divider 112 divides the clock signal by the numbers provided by the random generator to output a randomized clock signal to the signal transmitter 104. This spread spectrum method is commonly referred to as frequency hopping.

Operating in the manner described above, the random signal generator 108 in used to spread the signal transmitted by the transmitter 104 across a desired bandwidth. As will be understood by persons having ordinary skill in the art, the spread spectrum signal can be generated using a variety of other signal generation methods. Examples include phase modulation, frequency modulation, and/or amplitude modulation, where the modulation is either repetitive or random and may be either linear or discrete in nature. In another example, the spread spectrum signal is created with a random signal generator that outputs a random series that is applied directly to the signal source.

With further reference to FIG. 1, the device 100 additionally includes a signal processor 116, a central controller 118, and a user interface 120. As is evident from the description that follows, the signal processor 116 is used to measure the desired conditions so that they can be communicated to the user through the interface 120. By way of example, the user interface 120 can comprise a liquid crystal display (LCD) or a light emitting diode (LED) display (not shown) which provides a visual indication of the measured data to the user (e.g., medical technician), and a user input device (not shown) with which the spread spectrum measurement device 100 in controlled. As indicated in FIG. 1, the central controller 118 is at least connected to the random number generator 114 and the signal processor 116 to control their operation. Normally, the central controller 118 is also connected to the user interface 120 such that operation of the spread spectrum measurement device 100 in controlled by the user.

As will be appreciated by persons having ordinary skill in the art, the spread spectrum measurement device 100 is normally implemented in software. Portions of the device 100 are stored and transported on any computer readable medium (not shown) for use by or in connection with an instruction execution system, apparatus, or device, such as a computer-based system, processor containing system, or other system that can fetch the instructions from the instruction execution system, apparatus, or device and execute the instructions. In the context of this disclosure, a “computer-readable medium” can be any means that can contain, store, communicate, propagate, or transport the program for use by or in connection with the instruction execution system, apparatus, or device. The computer-readable medium can be, for example, an electronic, magnetic, optical, electromagnetic, infrared, or semiconductor system, apparatus, device, or propagation medium. More specific examples of computer-readable media include the following: an electrical connection having one or more wires, computer diskette, random access memory (RAM), read-only memory (ROM), erasable programmable read-only memory (EPROM or flash memory), an optical fiber, and a compact disk read-only memory (CD-ROM). It is to be noted that the computer-readable medium can even be paper or another suitable medium upon which the program is printed as the program can be electronically captured, via, for instance, optical scanning of the paper or other medium, then compiled, interpreted, or otherwise processed in a suitable manner if necessary, and then stored in a computer memory.

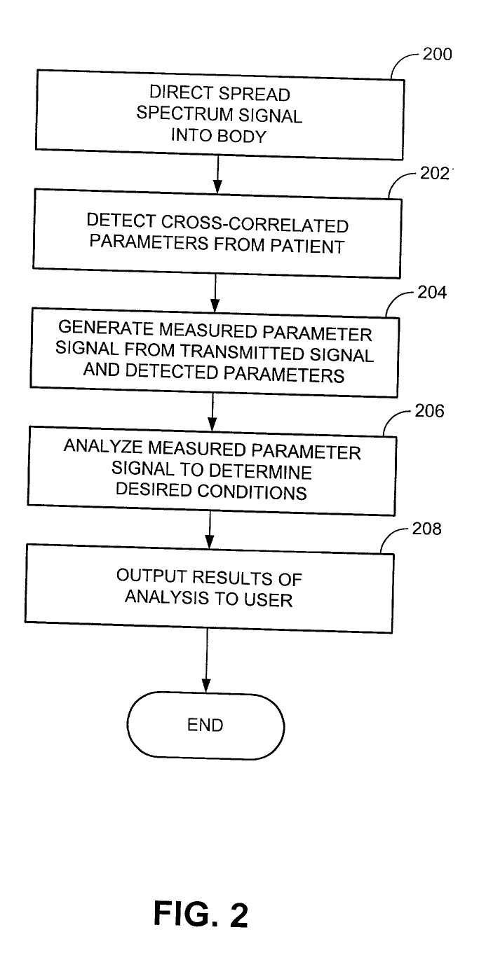

FIG. 2 illustrates a first method of measuring a desired condition. In particular, FIG. 2 provides a high level description of a method for measuring a condition relevant to a medical patient. By way of example, the condition can comprise the contact impedance of a device electrode, the patient's heart rate, the patient's respiration rate, or CPR applied to the patient. As will be apparent from the discussion that follows, the general measurement procedures are the same irrespective of which of these conditions are to be measured.

A spread spectrum signal is first directed into the medium, in this case a patient's body, in step 200. As identified above, the input signal can comprise a current signal or a voltage signal of known magnitude. In one arrangement, the signal is randomly spread across a frequency band of a desired width with the random signal generator 108. Alternatively, one or more of the alternative signal generator means identified above are used to spread the signal energy across a frequency band of desired width. Irrespective of the method with which the spread spectrum signal is formed, the transmission band normally is at a frequency higher and spread wider than the frequency band of the condition. For example, an impedance measurement band might range from approximately 1 to 2 KHz or from approximately 30 to 60 KHz depending on the measured parameter of interest. As will be appreciated by persons having ordinary skill in the art, spreading the input signal across a wide spectrum of frequencies in this manner greatly reduces the average power transmitted across any single frequency within the band such that less electrical interference is created by the device 100.

As the spread spectrum signal is transmitted into the body, a corresponding parameter is detected with the signal detector 106 in step 202. For instance, where the input signal comprises a current signal, the voltage sensed at the user interface 102 is measured. Alternatively, where the input signal comprises a voltage signal, the current sensed at the user interface 102 is measured. As identified above, the signal detector 106 is in electrical communication with the random signal generator 108 such that the detected parameters is cross-correlated with the transmitted parameters. Detecting across a frequency band in this manner reduces the influence of noise on the system in that detection is made at several different frequencies instead of a single frequency that may experience noise.

Once the particular parameter (e.g., voltage) has been detected with the signal detector 106, a measured parameter signal is generated in step 204. For instance, where the input signal comprises a current signal or a voltage signal and the detected parameter comprises a voltage or a current, respectively, the measured parameter can comprise an impedance signal. The measured parameter signal (e.g., impedance signal) can then be analyzed, in step 206, so as to measure the desired conditions. For instance, where the measured parameter signal is an impedance signal, the constant portion of the signal can be used to determine the contact impedance of device electrodes connected to the patient's chest. Additionally, the periodic modulations of the signal can be analyzed to determine patient conditions such as CPR activity, heart rate, and/or respiration rate. For instance, modulations having a period in the range of approximately 30 to 300 cycles per minute will pertain to heart rate while modulations have a period in the range of approximately 10 to 30 cycles per minute will pertain to respiration rate. The frequency and waveforms of these signal modulations is measured by the spread spectrum measurement device 100 and communicated to the user in step 208.

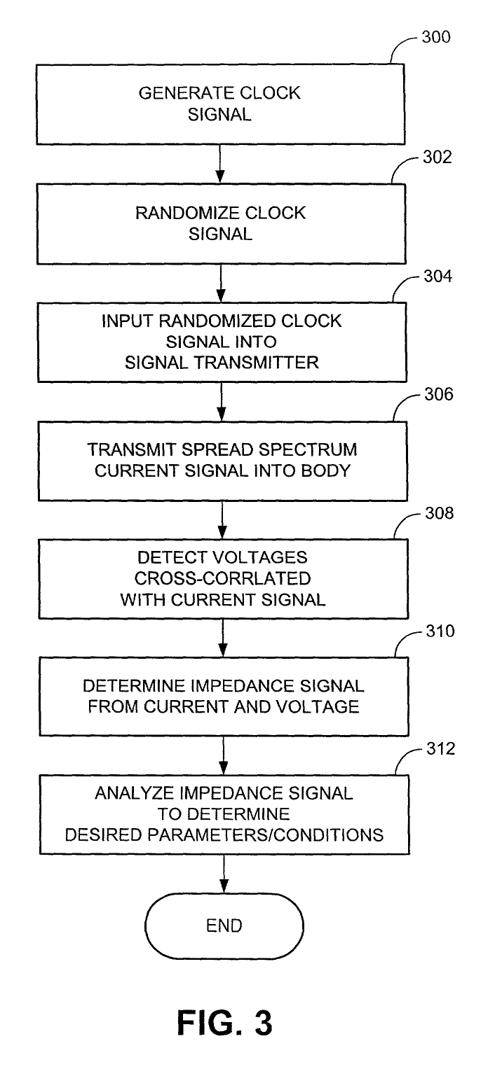

Referring now to FIG. 3, a second method for measuring a desired condition will be described. In particular, FIG. 3 provides a detailed description of a method for measuring contact impedance, patient heart rate, and/or patient respiration rate. With reference to step 300, a clock signal is generated. As described above, the clock signal can comprise a square waveform that toggles from an “on” position to an “off” position at a desired frequency that is generated by the clock signal generator 110. By way of example, the clock frequency can be set at approximately 3.84 MHz. To create a spread spectrum input signal with the clock signal, the clock signal is randomized, as indicated in step 302, such that the frequency with which the signal toggles on and off is varied within a desired frequency band. The clock signal can be randomized by randomly generating numbers within a predetermined range with the random number generator 114 and feeding the numbers into the divider 112. If, for example, if it is desired to produce input signals within a frequency band ranging from 30 to 60 kHz, the numbers generated for a 3.84 MHz clock signal will range from approximately 128 to 64. Once these numbers have been fed into the divider 112, the clock signal from the clock signal generator 110 are input into the divider 112 and sequentially divided by the random numbers supplied by the random number generator 114 to produce a randomized clock signal.

Once the randomized clock signal has been generated, it is inputted into the signal transmitter 104, in step 304. In a preferred arrangement, the transmitter 104 transmits a current spread spectrum current signal into the body, in step 306, via the medium interface 102. At this point, the voltage at the interface 102 (e.g., across the patient's chest) is measured, in step 308, with the signal detector 106 (e.g., a voltage detector). In that the current signal transmitted into the body varies with time across the selected spectrum, the detected signal similarly varies with time. However, since the randomized clock signal is fed into the signal detector 106, the voltage at any particular time, t, that corresponds to the transmitted current is known. Therefore, the impedance at any time can be determined.

From the current and voltage signals, an impedance signal, i.e., impedance as a function of time, is generated, in step 310, which provides the impedance at the interface 102 as a function of time. At this point, the impedance signal is analyzed to determine a variety of desired conditions in step 312. As known in the art, the constant portion of this impedance signal provides an indication of the contact impedance at the user interface 102. Therefore, the spread spectrum measurement device 100 is well-suited for use in a defibrillator to provide a means for determining whether proper contact is made between the defibrillator electrodes and the patient before applying an electric shock to the patient. Alternatively or in addition to this measurement, the device 100 can be used to determine the heart and/or respiration activity of the patient and/or any externally applied activity such as CPR. As identified above, these phenomena modulate the impedance signal at known periodic rates and can be correlated with internal electrical activity generated by the heart. Therefore, the beating of the patient's heart and/or the patient's breathing can be identified, for instance, with the signal processor 116. Once the heart beat and respiration have been identified, their frequency of occurrence can be measured to produce an estimate of the patient's heart rate and/or respiration rate that can be communicated to the user with the user interface 120. Notably, the time-varying impedance waveform can also be communicated to the user in similar manner, if desired.

In addition to transmission and detection of electrical signals, spread spectrum technologies can be used in alternative transmission/detection schemes. For instance, where the transmitted signal is an ultrasonic waveform used to image patient tissue and/or blood flow, a spread spectrum signal can be used to decrease the effects of noise on the signal. In an example scenario, a spread spectrum ultrasonic signal can be transmitted into the patient's chest with the signal transmitter 104 and medium interface 102 (e.g., ultrasound transducer). The echoes from this signal can then be detected with the medium interface 102 and the signal detector 106. The signal processor can be configured to detect modulations in the ultrasonic signal that pertain to particular patient conditions, for instance, patient heart beat and the like.

In another example, where the transmitted signal is an electromagnetic radiation signal such as a light signal used in pulse oximetry, a spread spectrum signal can similarly be used to decrease the effects of noise. By way of example, a spread spectrum electromagnetic radiation signal can be transmitted into the patient's finger or toe signal transmitter 104 and medium interface 102 (e.g., finger or toe clip). The red and infrared light energy signals can then be detected with the medium interface 102 and the signal detector 106. Again, the signal processor can be configured to detect modulations in the transmitted signal that pertain to the oxygenation of the patient's blood. Accordingly, it will be appreciated that spread spectrum techniques can be used in a variety of measurement and monitoring contexts within the medical field.

While particular embodiments of the invention have been disclosed in detail in the foregoing description and drawings for purposes of example, it will be understood by those skilled in the art that variations and modifications thereof can be made without departing from the spirit and scope of the invention as set forth in the following claims.

What is claimed is:

1. A method for measuring a desired condition, comprising:
directing a spread spectrum signal into a medium;
detecting a parameter that corresponds to the signal directed into the medium;
generating a measured parameter signal from the detected parameter; and
analyzing the measured parameter signal to determine the desired condition.

2. The method of claim 1, wherein the steps of directing a spread spectrum signal into a medium comprises transmitting a spread spectrum current signal into the medium.

3. The method of claim 2, wherein the steps of detecting a parameter that corresponds to the signal directed into the medium comprises measuring a voltage signal.

4. The method of claim 1, wherein the steps of directing a spread spectrum signal into a medium comprises transmitting a spread spectrum voltage signal into the medium.

5. The method of claim 4, wherein the steps of detecting a parameter that corresponds to the signal directed into the medium comprises measuring a current signal.

6. The method of claim 1, wherein the steps of generating a measured parameter signal from the detected parameter comprises generating an impedance signal.

7. The method of claim 6, wherein the steps of analyzing the measured parameter signal to determine the desired condition comprises analyzing the impedance signal to determine a contact impedance of a device electrode.

8. The method of claim 6, wherein the steps of analyzing the measured parameter signal to determine the desired condition comprises analyzing the impedance signal to determine a heart rate of a patient.

9. The method of claim 6, wherein the steps of analyzing the measured parameter signal to determine the desired condition comprises analyzing the impedance signal to determine a respiration rate of a patient.

10. The method of claim 1, wherein the steps of directing a spread spectrum signal into a medium comprises transmitting a spread spectrum ultrasound signal into the medium.

11. The method of claim 10, wherein the steps of analyzing the measured parameter signal to determine the desired condition comprises analyzing echoes of the ultrasound signal to determine the heart rate of a patient.

12. The method of claim 1, wherein the steps of directing a spread spectrum signal into a medium comprises transmitting a spread spectrum light signal into the medium.

13. The method of claim 12, wherein the steps of analyzing the measured parameter signal to determine the desired condition comprises analyzing detected red and/or infrared light level to determine the oxygenation level of a patient's blood.

14. The method of claim 1, further comprising generating a clock signal that is used to spread the signal directed into the medium across a desired frequency.

15. The method of claim 14, further comprising randomizing the clock signal.

16. The method of claim 15, wherein the clock signal is randomized with a random number generator and a divider.

17. A spread spectrum measurement device, comprising:
means for directing a spread spectrum signal into a medium;
means for detecting a parameter that corresponds to the signal directed into the medium;
means for generating a measured parameter signal from the detected parameter; and
means for analyzing the measured parameter signal to determine a desired condition.

18. A spread spectrum measurement device at least partially comprised within a computer readable medium, comprising:
logic configured to direct a spread spectrum signal into a medium;
logic configured to detect a parameter that corresponds to the signal directed into the medium;
logic configured to generate a measured parameter signal from the detected parameter; and
logic configured to analyze the measured parameter signal to determine a desired condition.

19. A spread spectrum measurement device, comprising:
a medium interface;
a signal transmitter configured to produce a spread spectrum input signal, the signal transmitter being in electrical communication with the medium interface;
a signal detector configured to detect a spread spectrum signal at the medium interface, the signal detector being in electrical communication with the medium interface; and
a signal processor configured to analyze the spread spectrum signal detected by the signal detector.

20. The device of claim 19, wherein the signal transmitter transmits a spread spectrum electrical signal.

21. The device of claim 19, wherein the signal transmitter transmits a spread spectrum ultrasound signal.

22. The device of claim 19, wherein the signal transmitter transmits a spread spectrum light signal.

23. The device of claim 19, further comprising a random signal generator in electrical communication with the signal transmitter and the signal detector.
